(19) United States
(12) Patent Application Publication
(10) Pub. No.: US 2024/0257186 A1
(43) Pub. Date: Aug. 1, 2024

(54) METHOD FOR PROVIDING EXPECTED PROFIT INFORMATION BASED ON E-COMMERCE AND COMPUTING DEVICE FOR EXECUTING THE SAME

(71) Applicant: CONIALAB CO., LTD., Seoul (KR)

(72) Inventor: HYUN JUNG NA, Gyeonggi-do (KR)

(21) Appl. No.: 18/422,211

(22) Filed: Jan. 25, 2024

(30) Foreign Application Priority Data
Jan. 26, 2023 (KR) 10-2023-0010448

(51) Int. Cl. G06Q 30/0273; G06Q 30/0241

(52) U.S. Cl. CPC G06Q 30/0274; G06Q 30/0277

(57) ABSTRACT

A method for providing expected profit information based on e-commerce according to an embodiment of the present disclosure is performed on a computing device including one or more processors and a memory that stores one or more programs executed by the one or more processors, and includes receiving an expected profit request from a seller terminal, calculating an expected profit of a product in response to the expected profit request and transmitting information about the expected profit to the seller terminal.

### CROSS-REFERENCE TO RELATED APPLICATION AND CLAIM OF PRIORITY

This application claims the benefit under 35 USC § 119 of Korean Patent Application No. 10-2023-0010448, filed on Jan. 26, 2023, in the Korean Intellectual Property Office, the entire disclosure of which is incorporated herein by reference for all purposes.

### BACKGROUND

### 1. Field

Embodiments of the present disclosure relate to a technology for providing expected profit information based on e-commerce.

### 2. Description of Related Art

With the development of information and communication technology, online commerce, that is, e-commerce, which involves selling a product by building an online market, has developed. The initial form of online commerce was in the form in which a seller opened an online shopping mall (hereinafter referred to as shopping mall) directly, registered the product, and a visitor who accessed the shopping mall purchased the product, but with the advent of intermediary shopping malls that connect a seller and a purchaser emerged and grew into a large shopping malls (e.g., Auction, 11th Street, G Market, etc.) by providing convenient sales and purchasing services, which leads to explosive growth in an e-commerce market. Since then, this explosive growth has continued with the emergence of social commerce using social networks (e.g., Tmon, Wemakeprice) and various forms of e-commerce (e.g., Coupang) that provide innovative offline distribution and logistics services. These large-scale e-commerce platforms (e.g., large intermediary platforms, social commerce, etc.) are bringing large profits to a user, especially the seller.

Recently, a new type of e-commerce market is being actively formed using communication channels with fans of highly influential individuals with great influence on social network services (SNS) (e.g., Facebook, Instagram) and individual media services (e.g., influencer, celebrity, etc.), or through strong personal networks in communities where people with similar personal interests gather.

### SUMMARY

Embodiments of the present disclosure are intended to provide a new method for providing expected profit information based on e-commerce and a computing device for executing the same.

According to an exemplary embodiment of the present disclosure, there is provided a method for providing expected profit information based on e-commerce performed on a computing device including one or more processors and a memory that stores one or more programs executed by the one or more processors, the method including receiving an expected profit request from a seller terminal, calculating an expected profit of a corresponding product in response to the expected profit request, and transmitting information about the expected profit to the seller terminal, in which the calculating of the expected profit includes providing a web page where a product category can be selected to the seller terminal, when the category is selected, providing a web page where products can be selected from the corresponding category to the seller terminal, when one or more products are selected, providing a web page where the number of recommended people for the selected product can be input to the seller terminal, and calculating an expected profit for each product based on a sales price, a basic profit rate, and the number of recommended people of the selected product, the calculating of the expected profit for each product includes calculating the number of people expected to purchase according to a purchase probability of the number of recommended people of the product, calculating an expected sales amount of the product by multiplying the number of people expected to purchase by the sales price of the product, and calculating the expected profit of the corresponding product by multiplying the expected sales amount of the product by the basic profit rate, the calculating of the number of people expected to purchase includes checking the number of recommended people of other sellers who sell the same or similar product as the product, setting an average value of actual product purchase rates of the number of recommended people of the other sellers as a purchase probability of the number of recommended people of the product, and calculating the number of people expected to purchase according to the set purchase probability.

The calculating of the expected profit may further include obtaining information on a target product related to the expected profit request, extracting content including a product related to the target product from among contents registered on a platform of an e-commerce environment, extracting a content creator team related to creation of the extracted content, and when the extracted content creator team creates product promotional content for the target product, calculating the expected profit for the target product.

The extracting of the content may include calculating a degree of similarity between the target product and each of products included in already registered content, and when the calculated degree of similarity is greater than or equal to a preset threshold value, determining that the corresponding product included in the content is related to the target product.

The calculating of the expected profit for the target product may include calculating an influence index of the extracted content creator team, when the content creator team creates the product promotional content for the target product based on the influence index of the content creator team, calculating an expected promotional sales volume for the target product, and calculating the expected profit of the target product for the content creator team based on the expected promotional sales volume for the target product.

The content creator team may include a first content creator who serves as a model for the content and a second content creator who is an expert in each field involved in creating the content, and the calculating of the influence index of the content creator team may include calculating an influence index of the first content creator, calculating an influence index of the second content creator, and calculating the influence index of the content creator team by adding the influence index of the first content creator and the influence index of the second content creator.

The influence index of the first content creator may be calculated based on one or more of the number of followers of the first content creator, the total number of uploaded contents, and the total number of social feedback on the uploaded content.

The influence index of the second content creator may be calculated based on one or more of the number of content creations and content creation experience of the second content creator.

In the calculating of the influence index of the content creator team, different weights may be assigned to the influence index of the first content creator and the influence index of the second content creator, respectively, depending on an attribute or type of the target product.

The calculating of the expected promotional sales volume for the target product may include storing a matching table in which the expected promotional sales volume is matched according to the influence index of the content creator team, and extracting the expected promotional sales volume matching the calculated influence index of the content creator team from the matching table.

According to another exemplary embodiment of the present disclosure, there is provided a computing device including one or more processors, a memory, and one or more programs, in which the one or more programs are stored in the memory and configured to be executed by the one or more processors, and the one or more programs include an instruction for receiving an expected profit request from a seller terminal, an instruction for calculating an expected profit of a corresponding product in response to the expected profit request, and an instruction for transmitting information about the expected profit to the seller terminal, and the instruction for calculating of the expected profit includes an instruction for providing a web page where a product category can be selected to the seller terminal, when the category is selected, an instruction for providing a web page where products can be selected from the category to the seller terminal, when one or more products are selected, an instruction for providing a web page where the number of recommended people for the selected product can be input to the seller terminal, and an instruction for calculating an expected profit for each product based on a sales price, a basic profit rate, and the number of recommended people of the selected product, the instruction for calculating of the expected profit for each product includes an instruction for calculating the number of people expected to purchase according to a purchase probability of the number of recommended people of the product, an instruction for calculating an expected sales amount of the product by multiplying the number of people expected to purchase by the sales price of the product, and an instruction for calculating the expected profit of the corresponding product by multiplying the expected sales amount of the product by the basic profit rate, the instruction for calculating of the number of people expected to purchase includes an instruction for checking the number of recommended people of other sellers who sell the same or similar product as the product, an instruction for setting an average value of an actual product purchase ratio of the number of recommended people of the other sellers as a purchase probability of the number of recommended people of the product, and an instruction for calculating the number of people expected to purchase according to the set purchase probability.

### BRIEF DESCRIPTION OF THE DRAWINGS

FIG. 1 is a diagram illustrating an e-commerce environment according to an embodiment of the present disclosure.

FIG. 2 is a flowchart illustrating a process of providing expected profit information of a seller by a platform server according to an embodiment of the present disclosure.

FIG. 3 is a diagram schematically illustrating a web page provided by the platform server to a seller terminal in response to an expected profit request of the seller according to an embodiment of the present disclosure.

FIG. 4 is a diagram illustrating a state in which the platform server provides the expected profit information to the seller terminal in an embodiment of the present disclosure.

FIG. 5 is a diagram illustrating a state in which the content creator registers content on the platform in the e-commerce environment according to an embodiment of the disclosure.

FIG. 6 is a flowchart for describing a process of providing the expected profit information by the platform server according to another embodiment of the present disclosure.

FIG. 7 is a block diagram for illustratively describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

In the following description, “transfer,” “communication,” “transmission,” “reception,” of a signal or information and other terms having similar meaning include not only direct transmission of a signal or information from one component to another component, but also transmission of the signal or information through another component. In particular, “transferring” or “transmitting” a signal or information to a component indicates a final destination of the signal or information and does not mean a direct destination. This is the same for “receiving” a signal or information. In addition, in this specification, the fact that two or more pieces of data or information are “related” means that if one data (or information) is acquired, at least part of the other data (or information) can be obtained based on it.

Additionally, terms such as first, second, etc. may be used to describe various components, but the components should not be limited by the terms. Terms may be used for the purpose of distinguishing one component from another. For example, a first component may be referred to as a second component, and similarly, the second component may also be referred to as a first component without departing from the scope of the present disclosure.

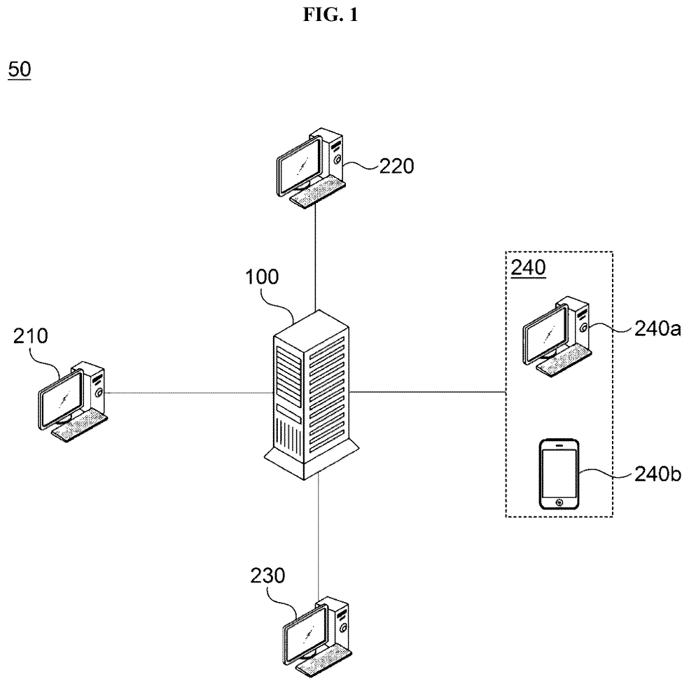

FIG. 1 is a diagram illustrating an e-commerce environment according to an embodiment of the present disclosure.

Referring to FIG. 1, the e-commerce environment 50 may include a platform server 100, a supplier terminal 210, a seller terminal 220, a content creator terminal 230, and a purchaser terminal 240. The platform server 100 may be connected to each of the supplier terminal 210, the seller terminal 220, the content creator terminal 230, and the purchaser terminal 240 through a communication network.

The platform server 100 may provide e-commerce platform services through user terminals 210, 220, 230, and 240. The e-commerce platform services may include overall services required to sell products online, such as product supply, sales, promotion, and purchase.

According to one embodiment, the platform server 100 may register a supplier of a product to be sold on the platform through the supplier terminal 210. The supplier may be, for example, a person who supplies the product to be sold on the platform and delivers the product sold by a seller. In other words, the supplier may be a person who is only responsible for product distribution and entrusts the rest to other users.

According to one embodiment, the platform server 100 may register the product supplied by the supplier through the supplier terminal 210. The platform server 100 may provide a service for managing product registration through the provider terminal 210. According to one embodiment, the platform server 100 may provide a list of registered products. According to one embodiment, the platform server 100 may update the list of registered products. For example, the platform server 100 may receive application information for registering a new product from the supplier, and add the product to the list if registration is approved. Additionally, the platform server 100 may receive request information for deleting a registered product from the supplier and delete the requested product from the list.

According to one embodiment, the platform server 100 may provide a service for managing product sales through the supplier terminal 210. According to one embodiment, the platform server 100 may provide sales information of the registered product. The sales information may include, for example, information such as sales volume, order amount, and deposit amount. According to one embodiment, the platform server 100 may provide a service for managing product inventory. For example, the inventory management service may be managed together with product registration.

According to one embodiment, the platform server 100 may provide settlement information for a sold product. The settlement information may include, for example, information about sales, settlement, and deposit. According to one embodiment, when receiving a settlement request from the supplier, the platform server 100 may process a process for paying a settlement amount.

According to one embodiment, the platform server 100 may provide a service necessary for product sales to the seller through the seller terminal 220. According to one embodiment, the platform server 100 may register the seller through the seller terminal 220. The seller may be, for example, a person who sells the product registered on the platform by the supplier. According to one embodiment, the platform server 100 may register a product available for sale of the seller through the seller terminal 220.

According to one embodiment, the platform server 100 may provide a comprehensive solution for selling the product through the seller terminal 220. According to one embodiment, the platform server 180 may provide a solution for creating an online shopping mall within the platform. For example, the platform server 180 may provide a function capable of creating an online shopping mall using a drag and drop method through a GUI without hard coding. Additionally, the platform server 180 may provide a premade design template.

According to one embodiment, the platform server 100 may register a product for sale of the seller in the online shopping mall. For example, the product for sale may be a product approved for sale to the seller. According to one embodiment, the platform server 100 may create an online shopping mall requested by the seller. For example, the platform server 100 may create the online shopping mall created by each seller. Each seller can create a separate online shopping mall according to his or her tastes. Accordingly, the purchaser may selectively subscribe to an online shopping mall that suits his or her tastes on the platform service, becomes a member, and purchase a registered product.

According to one embodiment, the platform server 100 may provide a service for managing the online shopping mall through the seller terminal 220. For example, the platform server 100 may provide a solution for setting the name, URL, logo, banner, etc. of the online shopping mall.

According to one embodiment, the platform server 100 may provide a list of products available for sale. According to one embodiment, the platform server 100 may update the list of products available for sale. For example, the platform server 100 may receive an approval application for selling a new product from the seller, and add the new product to the list when the sale is approved. According to one embodiment, the platform server 100 may receive profit rate setting information for the sold product from the seller.

According to one embodiment, the platform server 100 may provide sales information of the product sold in the online shopping mall to the seller terminal 220. The sales information may include, for example, information similar to information provided to the supplier, such as sales volume, order amount, deposit amount, etc., as well as member information of the purchaser. The platform server 100 may provide services for managing orders, delivery, and refunds to the seller terminal 220.

According to one embodiment, the platform server 100 may provide a service necessary for content provision to the supplier through the content creator terminal 230.

According to one embodiment, the platform server 100 may register a content creator. For example, the content creator may create content that helps sell a product and provide the created content to the supplier and the seller. According to one embodiment, the content creator may be an expert who is directly or indirectly required to create content. The professional personnel may include, for example, a model, a hair and makeup expert, a stylist, a photographer, an editor, etc. Additionally, the model may be an influencer, a celebrity, etc. on online social media.

According to one embodiment, the platform server 100 may provide a service that allows content created by the content creator to be shared with platform users. For example, the platform server 100 may provide a content sharing service that uses the platform users as social networks, that is, social network service (SNS). Accordingly, the content creator can upload the created content to a virtual space where he or she can be identified and share the content with the platform users.

According to one embodiment, the content shared through the content sharing service of the platform server 100 may be content for promoting the product sold on the platform. For example, the content may include information (e.g., URL) about the online shopping mall within the platform where the product being promoted is sold. Accordingly, the purchaser can move to a designated shopping mall using the information and purchase the product. According to one embodiment, the platform server 100 may provide information about participants (e.g., the model, the hair and makeup expert, the stylist, the photographer, etc.) who participated in creating the content together with the content. Accordingly, the supplier and the purchaser can easily check not only the model but also all parties concerned necessary for content creation.

According to one embodiment, the platform server 100 may provide the service necessary for product purchase to the supplier through the purchaser terminal 240.

According to one embodiment, the platform server 100 may register the purchaser as a member in the online shopping mall of the seller. For example, the platform server 100 may register the purchaser as a member in the online shopping mall of each seller.

According to one embodiment, the platform server 100 may receive order information of the purchaser who purchased a product through the online shopping mall. The order information may include, for example, the product and delivery information. According to one embodiment, the platform server 100 may provide a payment service to the purchaser who purchases the product. According to one embodiment, the platform server 100 may transmit the order information to the supplier and the seller when payment is completed. Accordingly, the supplier can deliver the ordered product to the purchaser.

According to one embodiment, the platform server 100 may provide a service for managing an order status through the purchaser terminal 240. According to one embodiment, the platform server 100 may provide the order and delivery information for the product purchased from the online shopping mall. According to one embodiment, when receiving order correction information, the platform server 100 may modify the order information based on the received correction information.

According to one embodiment, the platform server 100 may include a database (DB) for data storage, as well as a computing module necessary to provide the e-commerce platform service. In other words, the platform server 100 may include a server configuration generally required to provide the e-commerce service. According to one embodiment, the platform server 100 may provide useful information to a service user by analyzing information stored in the database. The useful information may include, for example, basic data useful for product supply, product sales, content creation, and product purchase and processed data.

According to one embodiment, the user terminals 210, 220, 230, and 240 may be general-purpose devices such as a desktop personal computer (PC), a laptop PC (notebook PC), a smartphone, a tablet PC, a personal digital assistant (PDA), etc. For example, the supplier terminal 210, the seller terminal 220, and the user terminal 230 may be electronic devices with relatively low portability, such as the desktop PC and the laptop PC. The purchaser terminal 240 may be a smartphone 240b as well as a desktop PC 240a with low portability.

The e-commerce environment 50 described above can provide the e-commerce platform service in which the suppliers who supply products, the sellers who create the online shopping mall to sell the products, and creators who create content to promote the products coexist on one platform, and which sells products to the purchasers, and shares profits from product sales.

Meanwhile, the platform server 100 may provide information about the expected profit from product sales according to the expected profit request of the seller. That is, the platform server 100 may receive the expected profit request from the seller who intends to open an online shopping mall or a seller who has opened an online shopping mall, and provide the seller with information about the expected profit (expected profit information) when selling one or more products included in the received expected profit request at the online shopping mall. In this case, the platform server 100 may provide a web page where categories and products can be selected to the seller terminal 220 of the seller who transmitted the expected profit request.

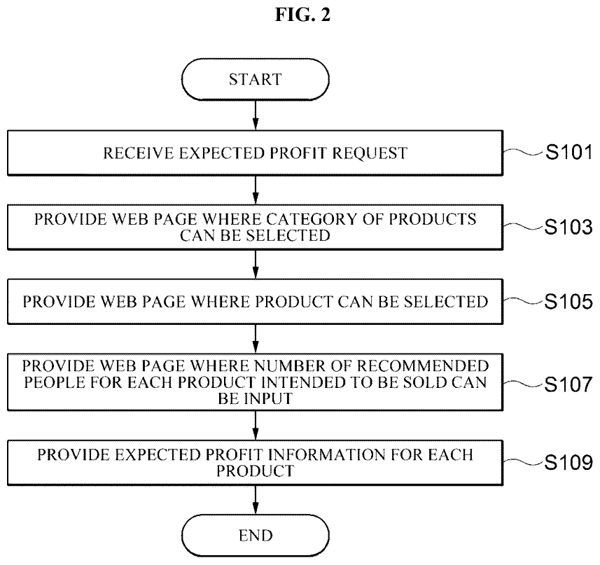

FIG. 2 is a flowchart illustrating a process of providing expected profit information of the seller by the platform server according to an embodiment of the present disclosure. In the illustrated flowchart, the method is described by being divided into a plurality of steps, but at least some of the steps may be performed in a different order, may be performed together in combination with other steps, omitted, may be performed by being divided into detailed steps, or may be performed by being added with one or more steps (not illustrated).

Referring to FIG. 2, the platform server 100 may receive the expected profit request from the seller terminal 220 (S 101). Here, the seller terminal 220 may be a terminal of the seller who intends to open the online shopping mall or has opened the online shopping mall through an e-commerce platform service.

In one embodiment, the seller who intends to open the online shopping mall may request the platform server 100 for how much the expected profit is when he or she opens the online shopping mall and sells a product. In addition, the seller who has already opened the online shopping mall may request the platform server 100 for how much the expected profit is when he or she sells a product other than the products he or she is currently selling.

Next, the platform server 100 may provide a web page where a category of the products can be selected to the seller terminal 220 (S 103). The seller can select a category of a field he or she wants from the web page displayed on a screen of the seller terminal 220.

Next, when the seller selects the category, the platform server 100 may provide the seller terminal 220 with a web page where products in the corresponding category can be selected (S 105). The seller may select one or more products he or she intends to sell from the web page displayed on the screen of the seller terminal 220.

Next, when the seller selects the product, the platform server 100 may provide the seller terminal 220 with a web page where the seller can input the number of recommended people for each product which is intended to be sold (S 107). The seller can input how many people the product can be recommended to for each product selected by the seller on the web page displayed on the screen of the seller terminal 220.

Next, the platform server 100 may provide expected profit information for each product to the seller terminal 220 based on a sales price, a basic profit rate, and the number of recommended people of the product selected by the seller (S 109).

Here, the basic profit rate is set for each product, and may be set to a certain profit rate or range of profit rate depending on the product. For example, the basic profit rate for product A may be set to 10%, the basic profit rate for product B may be set to 10 to 15%, and the basic profit rate for product C may be set to 15 to 20%.

In one embodiment, the platform server 100 may calculate the expected sales amount of the product based on the number of recommended people for the product and sales price of the product input by the seller. The platform server 100 may calculate the expected number of people to purchase based on a purchase probability of the number of recommended people of the product, and calculate the expected sales amount of the product by multiplying the calculated expected number of people to purchase by the sales price of the product. The platform server 100 may calculate the expected profit of the product by multiplying the expected sales amount of the product by the basic profit rate set for the corresponding product. The platform server 100 may calculate the expected profit of the product using the following equation.

$$Expected profit = ( ( number of recommended people \times purchase probability ) \times sales price ) \times basic profit rate \qquad [ Equation ]$$

In this case, the platform server 100 may divide the purchase probabilities of the number of recommended people into a plurality of preset levels (e.g., 10%. 20%, 30%, etc.), calculate the expected product profit according to the level of each of the purchase probabilities, and provide the expected product profit to the seller terminal 220.

In addition, the platform server 100 may calculate the purchase probability of the number of recommended people according to purchase information of number of recommended people of other sellers who sell the same or similar product as the corresponding product. In one embodiment, the platform server 100 may set an average value of actual product purchase rates of the number of recommended people from other sellers who sell the same or similar products as the purchase probability of the number of recommended people.

According to embodiments of the present disclosure, the expected profit information when selling a product other than the product currently sold can be provided to the seller who intends to sell the product by opening the online shopping mall or the seller who currently sells a product but intends to sell another product in the e-commerce environment.

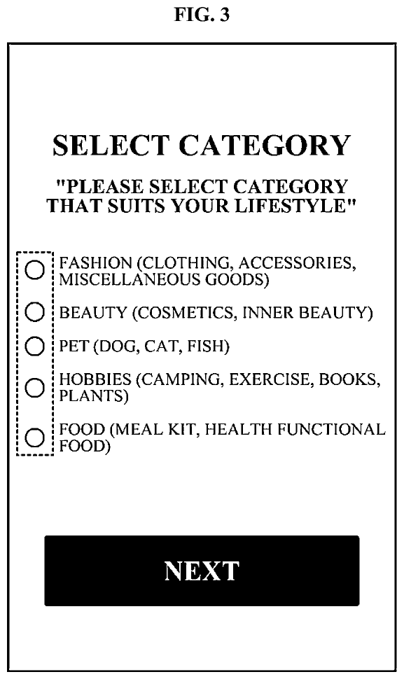

FIG. 3 is a diagram schematically illustrating the web page provided by the platform server 100 to the seller terminal 220 in response to the expected profit request of the seller according to an embodiment of the present disclosure.

The (a) of FIG. 3 is a web page where a category of products can be selected, and may be prepared to allow the seller to select categories such as fashion, beauty, pets, hobbies, food, etc.

The (b) of FIG. 3 is a web page where products can be selected from the selected category, and the web page may be provided in such a way that, for example, when the seller selects the category “Pet”, the seller can select one or more products such as brand A dog food, brand B cat tower, brand C dog shampoo, etc.

The (c) of FIG. 3 is a web page where the number of recommended people for each product selected can be input, and may be provided in such a way that the seller can input the number of recommended people for each product selected.

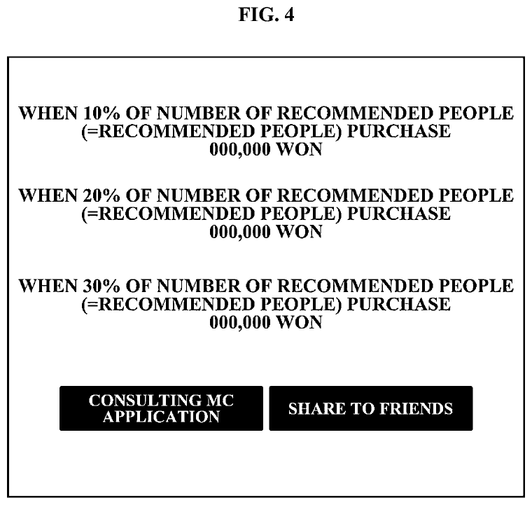

FIG. 4 is a diagram illustrating a state in which the platform server 100 provides expected profit information to the seller terminal 220 in an embodiment of the present disclosure. Referring to FIG. 4, when each of the purchase probabilities of the number of recommended people for the product input by the seller is set to 10%, 20%, or 30%, the platform server 100 may calculate the expected product profit according to the level of each purchase probability and provide the expected product profit to the seller terminal 220.

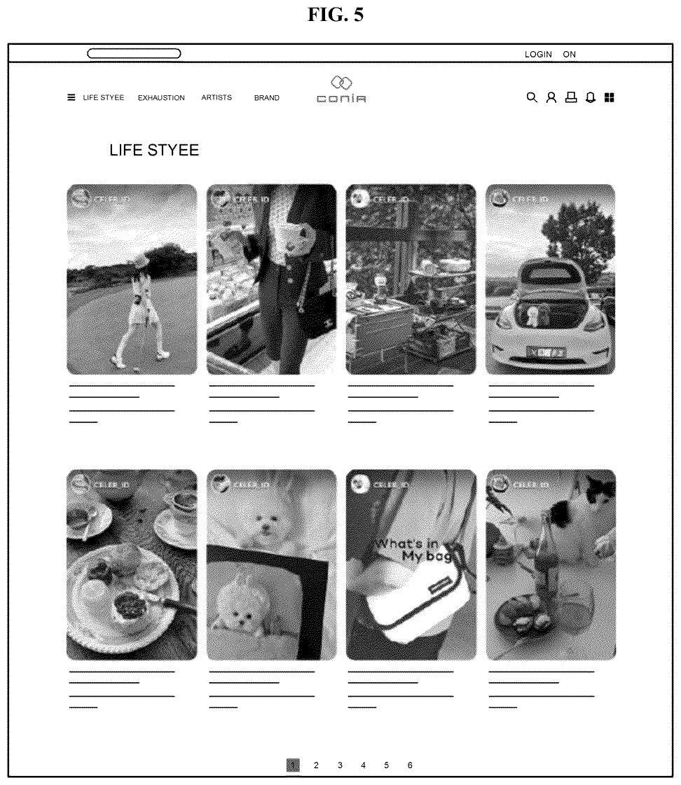

Meanwhile, in the e-commerce environment 50, each content creator can register content on the platform. FIG. 5 is a diagram illustrating a state in which the content creator registers content on the platform in the e-commerce environment according to an embodiment of the disclosure.

Referring to FIG. 5, the content creators may register photos or video images containing certain products (e.g., golf equipment, food, dolls, bags, camping gear, etc.) on the platform. The content creators may upload content containing the product using social network services provided on the platform. For example, the content creator may photograph the product he or she purchases or use in his or her daily lives and upload the product to the platform, but is not limited thereto. The content creator may also upload content containing the product that receive sponsored advertising.

Here, the content creators may also create content for promoting the product and upload the content to the platform. In this case, the content creators may be divided into a model (i.e., the influencer or the celebrity, etc.) of the content for promoting the product and an expert involved in creating content (e.g., a makeup expert, a stylist, a photographer, an editor, etc.).

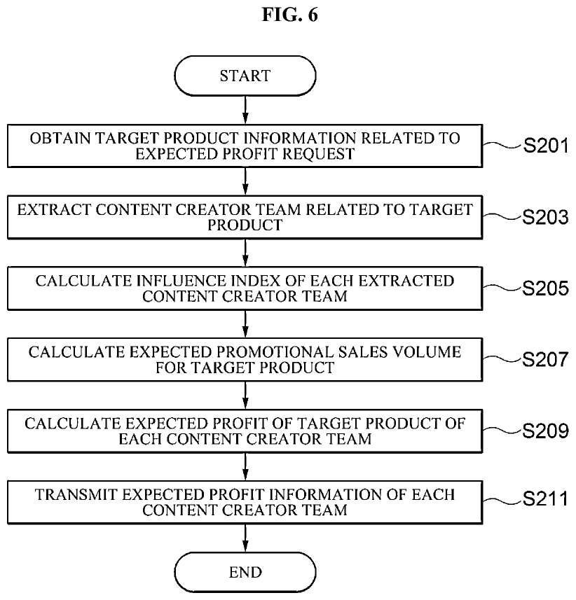

In one embodiment, when the expected profit request is received from the seller terminal 220, the platform server 100 may extract one or more content creators related to the product that the seller intends to sell, and provide information about an expected profit when product promotional content for the corresponding product is created by the extracted content creator to the seller terminal 220. A detailed description thereof will be made later with reference to FIG. 6.

FIG. 6 is a flowchart for describing a process of providing expected profit information by the platform server 100 according to another embodiment of the present disclosure. In the illustrated flowchart, the method is described by being divided into a plurality of steps, but at least some of the steps may be performed in a different order, may be performed together in combination with other steps, omitted, may be performed by being divided into detailed steps, or may be performed by being added with one or more steps (not illustrated).

Referring to FIG. 6, the platform server 100 may obtain target product information related to the expected profit request (S 201). The platform server 100 may receive the expected profit request from a certain seller terminal 220. The platform server 100 may obtain the target product information related to the expected profit request (name, brand, category, etc. of target product) by providing a web page that allows the seller terminal 220 to select the category and the product. However, the present disclosure is not limited thereto, and the platform server 100 may receive the target product information along with the expected profit request from the seller terminal 220.

Next, the platform server 100 may extract one or more content creator teams related to the target product for the expected profit request (S 203). That is, the platform server 100 may extract one or more contents including a product related to the target product for the expected profit request from among the contents registered on the platform. The platform server 100 may extract each of the content creator teams that created the extracted contents.

In one embodiment, the platform server 100 may calculate a degree of similarity between the target product for the expected profit request and each of the products included in the already registered content. When the calculated degree of similarity is greater than or equal to a preset threshold value, the platform server 100 may determine that the corresponding product is related to the target product.

Here, the content creator team may include the model (e.g., the influencer or celebrity) of the content and the expert in each field (e.g., the makeup expert, stylist, photographer, editor, etc.) involved in creating the content. Hereinafter, the model may be referred to as a first content creator, and the expert in each field may be referred to as a second content creator.

Next, the platform server 100 may calculate an influence index of each extracted content creator team (S 205). In one embodiment, the platform server 100 may calculate the influence index of the content creator team by adding the influence index of the first content creator and the influence index of the second content creator in the content creator team.

The platform server 100 may calculate the influence index of the first content creator based on one or more of the number of followers of the first content creator, the total number of uploaded contents, and the total number of social feedback for the uploaded contents. In addition, the platform server 100 may calculate the influence index of the second content creator based on one or more of the number of content creations and content creation experience of the second content creator in each field.

In this case, the platform server 100 may assign weights to the influence index of the first content creator and the influence index of the second content creator, respectively, depending on the attribute or type of the target product.

For example, if the target product is one for which the model is an important element in promoting the product, such as a fashion or beauty-related product, the platform server 100 may assign a higher weight to the influence index of the first content creator and a lower weight to the influence index of the second content creator.

Additionally, if the target product is one for which the photographic technique and the editing technique are important factors in promoting the product, such as food or home appliance-related products, the platform server 100 may assign a higher weight to the influence index of the second content creator and a lower weight to the influence index of the first content creator.

Next, the platform server 100 may calculate an expected promotional sales volume for the target product when each content creator creates product promotional content for the target product based on the influence index of each content creator team (S 207).

In one embodiment, the platform server 100 may store a matching table in which the expected promotional sales volume is matched according to the influence index. The platform server 100 may extract the expected promotional sales volume that matches the calculated influence index of the content creator team from the matching table.

Next, the platform server 100 may calculate the expected profit of each target product based on the expected promotional sales volume of each content creator team (S 209).

The platform server 100 may calculate the expected sales amount of the target product by multiplying the expected promotional sales volume of each content creator team by the sales price of the target product and then multiplying the expected sales amount of the target product by the base profit rate.

Next, the platform server 100 may transmit the expected profit information of the target product related to each content creator team to the seller terminal 220 (S 211). In this case, the platform server 100 may transmit information about the expected promotional costs required to create product promotional content along with the expected profit information through the content creator team to the seller terminal 220.

In one embodiment, when the number of content creator teams exceeds the preset number, the platform server 100 may transmit the expected profit information of the target product to the seller terminal 220 only for the content creator teams whose expected profit of the target product is included in a preset ranking among the content creator teams.

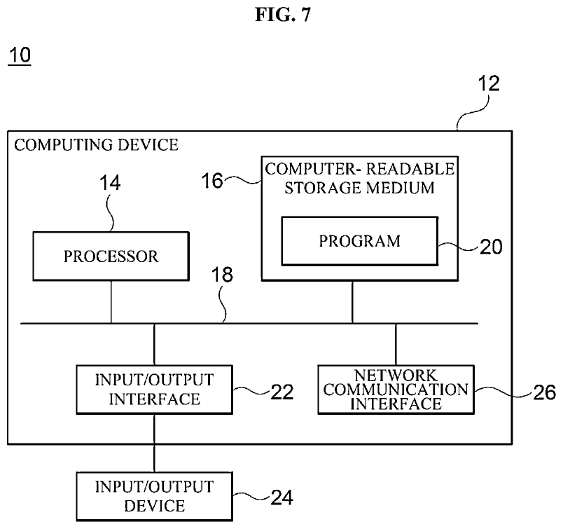

FIG. 7 is a block diagram for illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In one embodiment, the computing device 12 may be the platform server 100. Additionally, computing device 12 may be the supplier terminal 210. Additionally, the computing device 12 may be the seller terminal 220. Additionally, the computing device 12 may be the content creator terminal 230. Additionally, the computing device 12 may be the purchaser terminal 240.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to embodiments of the present disclosure, the expected profit information when selling a product other than the product currently sold can be provided to the seller who intends to sell the product by opening an online shopping mall or the seller who currently sells a product but intends to sell another product in an e-commerce environment. In addition, when the content creator team that registered the product related to the target product for the expected profit request creates product promotional content for the target product, expected profit information for the target product can be provided.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

What is claimed is:

1. A method for providing expected profit information based on e-commerce performed on a computing device including one or more processors and a memory that stores one or more programs executed by the one or more processors, the method comprising:
receiving an expected profit request from a seller terminal;
calculating an expected profit of a corresponding product in response to the expected profit request; and
transmitting information about the expected profit to the seller terminal,
wherein the calculating of the expected profit includes providing a web page where a product category can be selected for the seller terminal, when the category is selected, providing a web page where products can be selected from the corresponding category to the seller terminal, when one or more products are selected, providing a web page where the number of recommended people for the selected product can be input to the seller terminal, and calculating an expected profit for each product based on a sales price, a basic profit rate, and the number of recommended people of the selected product, and
the calculating of the expected profit for each product includes calculating the number of people expected to purchase according to a purchase probability of the number of recommended people of the product, calculating an expected sales amount of the product by multiplying the number of people expected to purchase by the sales price of the product, and calculating the expected profit of the corresponding product by multiplying the expected sales amount of the product by the basic profit rate,
wherein the calculating of the number of people expected to purchase includes checking the number of recommended people of other sellers who sell the same or similar product as the product, setting an average value of actual product purchase rates of the number of recommended people of the other sellers as a purchase probability of the number of recommended people of the product, and calculating the number of people expected to purchase according to the set purchase probability.

2. The method of claim 1, wherein the calculating of the expected profit further includes:
obtaining information on a target product related to the expected profit request;
extracting content including a product related to the target product from among contents registered on a platform of an e-commerce environment;
extracting a content creator team related to creation of the extracted content; and
when the extracted content creator team creates product promotional content for the target product, calculating the expected profit for the target product.

3. The method of claim 2, wherein the extracting of the content includes:
calculating a degree of similarity between the target product and each of products included in already registered content; and
when the calculated degree of similarity is greater than or equal to a preset threshold value, determining that the corresponding product included in the content is related to the target product.

4. The method of claim 2, wherein the calculating of the expected profit for the target product includes:
calculating an influence index of the extracted content creator team;
when the content creator team creates the product promotional content for the target product based on the influence index of the content creator team, calculating an expected promotional sales volume for the target product; and
calculating the expected profit of the target product for the content creator team based on the expected promotional sales volume for the target product.

5. The method of claim 4, wherein the content creator team includes a first content creator who serves as a model for the content and a second content creator who is an expert in each field involved in creating the content, and
the calculating of the influence index of the content creator team includes:
calculating an influence index of the first content creator;
calculating an influence index of the second content creator; and
calculating the influence index of the content creator team by adding the influence index of the first content creator and the influence index of the second content creator.

6. The method of claim 5, wherein the influence index of the first content creator is calculated, based on one or more of the number of followers of the first content creator, the total number of uploaded contents, and the total number of social feedback on the uploaded content.

7. The method of claim 5, wherein the influence index of the second content creator is calculated, based on one or more of the number of content creations and content creation experience of the second content creator.

8. The method of claim 5, wherein, in the calculating of the influence index of the content creator team, different weights are assigned to the influence index of the first content creator and the influence index of the second content creator, respectively, depending on an attribute or type of the target product.

9. The method of claim 4, wherein the calculating of the expected promotional sales volume for the target product includes:
storing a matching table in which the expected promotional sales volume is matched according to the influence index of the content creator team; and
extracting the expected promotional sales volume matching the calculated influence index of the content creator team from the matching table.

10. A computing device comprising:
one or more processors;
a memory; and
one or more programs stored in the memory and configured to be executed by the one or more processors, the one or more programs including:
an instruction for receiving an expected profit request from a seller terminal;
an instruction for calculating an expected profit of a corresponding product in response to the expected profit request; and
an instruction for transmitting information about the expected profit to the seller terminal,
wherein the instruction for calculating of the expected profit includes an instruction for providing a web page where a product category can be selected to the seller terminal, when the category is selected, an instruction for providing a web page where products can be selected from the category to the seller terminal, when one or more products are selected, an instruction for providing a web page where the number of recommended people for the selected product can be input to the seller terminal, and an instruction for calculating an expected profit for each product based on a sales price, a basic profit rate, and the number of recommended people of the selected product, and
the instruction for calculating of the expected profit for each product includes an instruction for calculating the number of people expected to purchase according to a purchase probability of the number of recommended people of the product, an instruction for calculating an expected sales amount of the product by multiplying the number of people expected to purchase by the sales price of the product, and an instruction for calculating the expected profit of the corresponding product by multiplying the expected sales amount of the product by the basic profit rate,
wherein the instruction for calculating the number of people expected to purchase includes an instruction for checking the number of recommended people of other sellers who sell the same or similar product as the product, an instruction for setting an average value of an actual product purchase ratio of the number of recommended people of the other sellers as a purchase probability of the number of recommended people of the product, and an instruction for calculating the number of people expected to purchase according to the set purchase probability.

11. A computer program stored in a non-transitory computer readable storage medium, the computer program including one or more instructions that, when executed by a computing device including one or more processors, cause the computing device to perform:
receiving an expected profit request from a seller terminal;
calculating an expected profit of a corresponding product in response to the expected profit request; and
transmitting information about the expected profit to the seller terminal,
wherein the calculating of the expected profit includes providing a web page where a product category can be selected to the seller terminal, when the category is selected, providing a web page where products can be selected from the category to the seller terminal, when one or more products are selected, providing a web page where the number of recommended people for the selected product can be input to the seller terminal, and calculating an expected profit for each product based on a sales price, a basic profit rate, and the number of recommended people of the selected product, and
the calculating of the expected profit for each product includes calculating the number of people expected to purchase according to a purchase probability of the number of recommended people of the product, calculating an expected sales amount of the product by multiplying the number of people expected to purchase by the sales price of the product, and calculating the expected profit of the corresponding product by multiplying the expected sales amount of the product by the basic profit rate,
wherein the calculating of the number of people expected to purchase includes checking the number of recommended people of other sellers who sell the same or similar product as the product, setting an average value of actual product purchase rates of the number of recommended people of the other sellers as a purchase probability of the number of recommended people of the product, and calculating the number of people expected to purchase according to the set purchase probability.
